(19) United States
(12) Patent Application Publication
(10) Pub. No.: US 2025/0096425 A1
(43) Pub. Date: Mar. 20, 2025

(54) CONNECTION DEVICE FOR THE ELECTRICAL CONNECTION OF TWO TERMINALS OF TWO ELEMENTARY CELLS OF A BATTERY PACK

(71) Applicant: A Raymond et Cie, Grenoble (FR)

(72) Inventors: Anthony Sanchez, Grenoble (FR); Mathieu Cochard, Grenoble (FR)

(21) Appl. No.: 18/832,013

(22) PCT Filed: Jan. 12, 2023
(86) PCT No.: PCT/EP2023/050605

§ 371 Date: Jul. 22, 2024

(30) Foreign Application Priority Data
Jan. 24, 2022 (FR) FR2200560

(51) Int. Cl. H01M 50/503; H01M 50/209; H01M 50/514; H01R 4/48; H01R 4/70

(52) U.S. Cl. CPC H01M 50/503; H01M 50/209; H01M 50/514; H01R 4/48; H01R 4/70

(57) ABSTRACT

A removable connection device is usable for connecting two adjacent cells of a battery pack, each provided with a terminal. The two terminals are arranged symmetrically with respect to the plane P, while the connection device is symmetrical with respect to a plane S. The connection device comprises a coupling element held by an insulation housing. The coupling element, which is configured to be coupled in a sliding connection in a direction with the two terminals, comprises a contact member and a spring member. The contact member is configured to establish electrical contact between the two terminals, while the spring member is configured to press the contact member against the two terminals. The insulation housing is configured to allow the coupling element to be handled for coupling in sliding connection by one side, referred to as the coupling side, with the two terminals.

### CROSS-REFERENCE TO RELATED APPLICATIONS

This application is a national phase entry under 35 U.S.C. § 371 of International Patent Application PCT/EP2023/050605, filed Jan. 12, 2023, designating the United States of America and published as International Patent Publication WO 2023/138971 A1 on Jul. 27, 2023, which claims the benefit under Article 8 of the Patent Cooperation Treaty of French Patent Application Serial No. FR2200560, filed Jan. 24, 2022.

### TECHNICAL FIELD

The present disclosure relates to the field of batteries, and more particularly to the field of batteries for electric vehicles. Notably, the present disclosure relates to a battery cell connection device.

### BACKGROUND

Batteries for powering electric vehicles generally comprise a plurality of elementary cells electrically connected to each other in parallel or in series. Electrical connections are made, in particular, by way of connection devices. In particular, each connection device is configured to electrically connect two electrical terminals of two adjacent elementary cells.

In this respect, FIG. 1 illustrates the use of a connection device 5, known from the prior art, to electrically connect an assembly of two elementary cells 1 and 2 of generally parallelepiped shape. The connection device 5 comprises two contact portions known respectively as the first portion 6 and the second portion 7, connected by a central portion 8. The elementary cells 1 and 2 comprise, respectively, a first terminal 3 and a second terminal 4 electrically connected by the connection device 5. In particular, the electrical connection is made by welding with solder the connection device 5 to either the first terminal 3 or the second terminal 4.

However, the consideration of holding together the connection device 5 by way of welds is not satisfactory. The latter do not allow easy, damage-free removal of the elementary cells. In particular, according to this approach, there is no option to individually replace a damaged elementary cell connected to other elementary cells without also having to replace these other cells.

To at least partly overcome this drawback, a battery pack generally comprises a set of modules, each formed by individual cells connected together by the connection device 5 described above. In this way, detecting a damaged elementary cell within a given module will only require the replacement of the module in question. However, this modular approach leaves some volumes vacant.

This is despite the fact that all-electric motor vehicles require an increase in the density of available energy, and consequently an increase in the space available for elementary cells.

One aim of the present disclosure is therefore to provide a device for connecting elementary cells that can be easily removed without damaging the cells.

Another aim of the present disclosure is to provide a device for connecting elementary cells, paving the way for integrating a larger number of elementary cells in a given volume.

### BRIEF SUMMARY

The aims of the present disclosure are, at least in part, achieved by a removable connection device for connecting two elementary cells of a battery pack, adjacent via a plane P, and each provided with a terminal, the two terminals being arranged symmetrically with respect to the plane P. The connection device is symmetrical with respect to a plane S, coincident with the plane P when the connection device is providing the connection between the two terminals. The connection device comprises a coupling element held by an insulation housing. The coupling element, configured to be coupled in a sliding connection in a direction X with the two terminals, comprises a contact member and a spring member kept mechanically secured to each other, the contact member being configured, once the coupling element is coupled with the two terminals, to establish an electrical contact between the two terminals, while the spring member is configured to press, by spring action, the contact member against both of the two terminals. The insulation housing, to which the coupling element is attached, is configured to allow handling of the contact element in order for it to be coupled in sliding connection on one side, referred to as the coupling side, with the two terminals.

According to one embodiment, the contact member, made from a generally rectangular metal sheet, comprises two contact portions that are symmetrical to one another with respect to the plane S and connected by a central portion. which extends in the direction X when the contact element is coupled to the two terminals, each of the contact portions being intended to bear, by one surface referred to as the free surface of the contact member, against a contact surface, which is perpendicular to the plane P, of each of the terminals.

According to one embodiment, the spring member, made from a metal sheet, comprises a main portion, which is connected to the contact member by conformingly covering a surface of the contact member opposite the free surface, and the spring member also comprises two curved side portions, which are arranged on the side of the main portion, each side portion comprising a bearing portion that extends opposite the free surface in the direction X.

According to one embodiment, each bearing portion is configured to ensure the sliding connection with terminals that each comprise, from the contact surface thereof, an upper portion and a lower portion that forms a cut-out with respect to the upper portion so as to provide a contour surface opposite the contact surface, each bearing portion being configured to bear against the contour surface in order to exert a spring effect, which makes it possible to press the contact member against the contact surface of the two terminals.

According to one embodiment, the contact member comprises two tabs, referred to as upper tabs, and the spring member comprises two other tabs, referred to as lower tabs, each lower tab facing an upper tab, and a lower tab and an upper tab, which face one another extending divergently from the coupling side and with respect to a plane that is perpendicular to the plane S and which includes the elongation direction of the central portion.

In one embodiment, each contact portion comprises stamped contacts that project with respect to the free surface and are intended to ensure electrical contact with the contact surface.

In one embodiment, the insulation housing comprises a main part, which conformingly covers and matches the main portion and at least in part the two side portions.

According to one embodiment, the insulation housing is in sliding connection with the coupling element in the extension direction of the central portion, and the insulation housing also comprises an abutment wall against which a side of the coupling element opposite the coupling side abuts.

According to one embodiment, the insulation housing comprises a support beam that extends in parallel with the extension direction of the central portion, the support beam being vertically in line with the central portion via the free surface, the support beam advantageously having a vaulted profile in a sectional plane that is perpendicular to the extension direction thereof.

According to one embodiment, the coupling element comprises a base from which two wings extend toward the coupling side such that the coupling element has, in section along the plane S, a U-shaped cross section.

According to one embodiment, both the contact member and the spring member are each formed from a metal sheet, the metal sheets being glued together, the spring member being arranged inside the contact member, and the outer surfaces of each of the wings are intended to be in contact with the two terminals.

According to one embodiment, the coupling element is configured to be inserted in a passage that extends in the direction X, and which is delimited by two coplanar upper end plates, respectively, of the two terminals, and by two coplanar lower end plates, respectively, of the two terminals, the upper end plate and the lower end plate of each terminal being in parallel with a plane C that is perpendicular to the plane P, and being connected by an angled portion, the coupling element also being configured to internally connect the upper end plates and the lower end plates.

According to one embodiment, the insulation housing comprises a handling element provided with an abutment wall and a main wall, the main wall being perpendicular to the abutment wall and extending from the abutment wall substantially in parallel with the wings of the coupling element, and the insulation housing also comprises embedding means, which are arranged on an internal surface of the abutment wall and are configured to support, by embedding, the coupling element from the base thereof on the abutment wall.

According to one embodiment, the embedding means comprise ribs that delimit a housing in which the coupling element is embedded by the base thereof.

According to one embodiment, the main wall comprises a rib, referred to as the central rib, which extends from the abutment wall toward the coupling side and is configured to be inserted between the two upper end plates.

According to one embodiment, the insulation housing further comprises two fastening elements, each fastening element being fixed to a terminal and intended to engage with the handling element by snap-fitting element.

According to one embodiment, each fastening element comprises an insulation wall, which covers the angled portion of a terminal, the insulation wall being provided with a lug while the handling element is provided with two catch means, which are configured to engage with the lugs by snap-fitting in order to fix the coupling between the contact element and the terminals.

According to one embodiment, each fastening element comprises a fastening base, which is configured to attach the fastening element to a pedestal on which the terminal rests.

The present disclosure also relates to a battery pack formed by a plurality of elementary cells stacked against one another in a stacking direction and electrically connected in series by way of connection devices according to the present disclosure.

### BRIEF DESCRIPTION OF THE DRAWINGS

Other features and advantages of the present disclosure will emerge from the following detailed description of embodiments of the present disclosure with reference to the appended figures, in which:

FIG. 1 illustrates the use of a connection device, known from the prior art, for the electrical connection of two individual cells of a battery pack;

FIG. 2 is a schematic view of two adjacent elementary cells of a battery pack, with both cells shown in perspective view;

FIG. 3 is a perspective view of a connection device according to a first embodiment of the present disclosure;

FIG. 4 is a schematic perspective view of the coupling element of the connection device of FIG. 3;

FIG. 5 is a schematic perspective view, of the contact member of the coupling element of FIG. 4;

FIG. 6 is an illustration of terminals capable of being implemented in the context of the first embodiment of the present disclosure;

FIG. 7 is a schematic perspective view of the spring member of the coupling element of FIG. 4;

FIG. 8 is a perspective view of the insulation housing of the connection device of FIG. 3;

FIG. 9 is a perspective view of a connection device according to a second embodiment of the present disclosure;

FIG. 10 is a schematic perspective view of the coupling element of the connection device of FIG. 9;

FIG. 11 is an illustration of terminals capable of being implemented in the context of the second embodiment of the present disclosure;

FIG. 12 is an illustration of the terminals of FIG. 11 coupled with the coupling element of FIG. 10;

FIG. 13 is a schematic view of the insulation housing of the connection device of FIG. 9;

FIG. 14 is a schematic view of a connection device, according to the second embodiment, connecting two terminals.

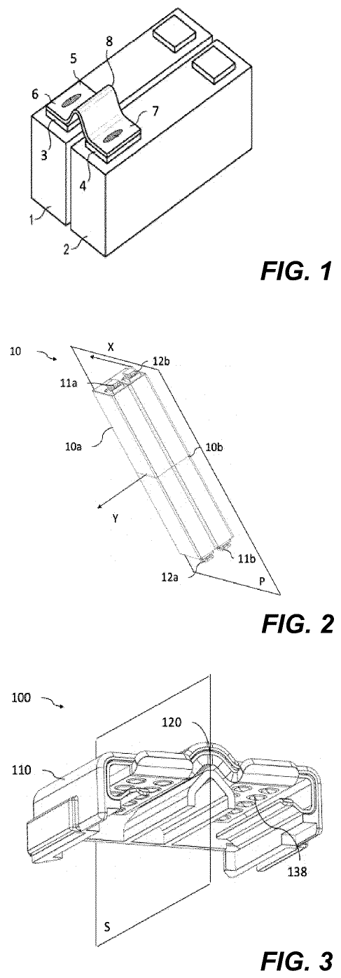

### DETAILED DESCRIPTION

The present disclosure relates to a removable connection device for connecting two elementary cells of a battery pack, adjacent to one another via a plane P, each provided with a terminal. In particular, the two terminals are arranged symmetrically with respect to plane P, while the connection device is symmetrical with respect to a plane S, coincident with plane P, when the connection device is providing the connection between the two terminals. The connection device comprises a coupling element, which is supported by an insulation housing. In particular, the coupling element, which is configured to be coupled in sliding connection in an direction X with the two terminals, comprises a contact member and a spring member kept mechanically secured to each other. The contact member is configured, when the coupling element is coupled with the two terminals, to establish electrical contact between the two terminals, while the spring member is configured to press, by spring action, the contact member against both of the two terminals. The insulation housing, to which the coupling element is attached, is configured to allow handling of the contact element in order for it to be coupled in sliding connection on one side, referred to as the coupling side, with the two terminals.

FIG. 2 shows two elementary cells 10a and 10b of a battery pack 10. Each elementary cell 10a and 10b is prismatic in shape, particularly parallelepipedic. In particular, the two elementary cells 10a and 10b are part of a set of elementary cells stacked against each other in a direction Y, forming a battery pack that can be used to power a motor vehicle. In particular, the two elementary cells 10a and 10b are adjacent to each other. More particularly, one side face of the elementary cell 10a faces one side face of the elementary cell 10b. It is understood that these two side faces are perpendicular to the direction Y. By convention, two elementary cells adjacent along a plane P means that one of the elementary cells has a side face facing a side face of the other elementary cell, with the two facing side faces having the plane P as their median plane.

Each elementary cell 10a and 10b comprises two terminals. In particular, the elementary cell 10a comprises a positive terminal 11a and a negative terminal 12a. Equivalently, the elementary cell 10b further comprises a positive terminal 11b and a negative terminal 12b. The two terminals of an elementary cell can each be arranged on the same face or on two opposite faces of the elementary cell. It is understood, without needing to be specified, that the two terminals of two elementary cells to be connected are each arranged on a face of the elementary cell to which they belong, the two faces in question being coplanar.

The connection device according to the present disclosure is configured to electrically connect a terminal of the elementary cell 10a with a terminal of the elementary cell 10b. This can be a parallel or series electrical connection. The remainder of the description will be limited to a series connection without, however, limiting the scope of the present disclosure to this aspect alone.

The connection device according to the present disclosure is configured to connect the positive terminal 11a with the negative terminal 12b. The positive terminal 11a and negative terminal 12b are arranged symmetrically with respect to plane P.

The connection device comprises a coupling element designed to be coupled with either of the two terminals 11a and 12b. “Coupled with either of the two terminals 11a and 12b,” means establishing an electrical connection between these two terminals. More particularly, and according to the present disclosure, the coupling of the coupling element with the two terminals 11a and 12b, involves a sliding connection along a direction X between the coupling element and the two terminals. The coupling element according to the present disclosure comprises a contact member and a spring member kept mechanically secured to each other. In particular, the contact member is configured, once the coupling element is coupled with the two terminals, to establish an electrical connection between the terminals. The spring member is configured to press the contact member by spring action against either of the two terminals. In this way, the electrical connection between the two terminals is made by pressing the contact member against the two terminals. As a result, it is not necessary to use soldering points. In other words, the coupling element, slidably coupled to the two terminals, is removable and can therefore be removed without damaging the elementary cells.

Finally, the connection device according to the present disclosure further comprises an insulation housing. This insulation housing, to which the coupling element is attached, is configured to allow handling of the contact element in order for it to be coupled in sliding connection on one side, referred to as the coupling side, with the two terminals.

FIG. 3 is a schematic view of a connection device 100 according to a first embodiment of the present disclosure. The connection device 100 comprises the insulation housing 110 and the coupling element 120. More particularly, the coupling element 120 is inserted into the insulation housing 110 so that the connection device 100 can be connected to both terminals by manipulating the insulation housing 110.

Furthermore, the connection device 100 is symmetrical with respect to a plane S, coincident with the plane P when the connection device 100 provides the connection between the two terminals 11a and 12b. It is understood that when the connection device 100 is symmetrical with respect to the plane S, each of the elements or members forming it are also symmetrical with respect to the plane S.

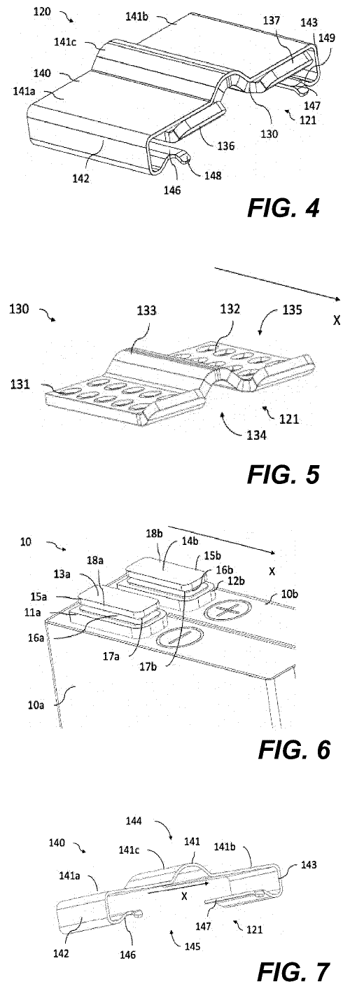

FIG. 4 is a representation of the coupling element 120 from FIG. 3. The coupling element comprises a contact member 130 and a spring member 140 (it is understood that the coupling element can be formed of a single part). The coupling element is further configured to be engaged in sliding connection, for coupling with the terminals, by one of its sides called the coupling side 121 (FIG. 3 and FIG. 4).

More particularly, the contact member 130, also shown in FIG. 5, is formed from a metal sheet of essentially rectangular shape.

In particular, the contact member 130 comprises two contact portions 131 and 132 symmetrical to each other with respect to the plane S and connected by a central portion 133, which extends in a direction of elongation perpendicular to the coupling side 121. In particular, the direction of elongation is parallel to direction X when the coupling element is coupled to the two terminals 11a and 12b. Each of the contact portions 131 and 132 is rectangular in shape and is designed to bear, via a face, known as the free surface 134, of the contact member, against a contact surface, perpendicular to the plane P, of each of the terminals.

More specifically, the contact portion 131 is designed to bear against the contact surface 13a of the terminal 11a, while the contact portion 132 is designed to bear against the contact surface 14b of the terminal 11b.

Each contact portion 131 and 132 may comprise stamped contacts 138 that project from the free surface 134, intended to ensure electrical contact with the contact surfaces 13a and 14b (FIG. 3).

The central portion 133 can have a concave shape through the free surface 134, and more particularly form a gutter.

The spring member 140 shown in FIG. 7 can also be made of metal sheet.

In particular, the spring member 140 may comprise a main portion 141. The main portion 141 comprises an upper surface 144 and a lower surface 145, opposite to the upper surface 144, the lower surface 145 being a surface whereby the main portion 141 is bonded to the contact member 130. More particularly, the lower surface 145 conformingly covers a surface 135 (FIG. 5) of the contact member 130 opposite the free surface 134. “Bonded” is understood to mean glued, welded, mechanically clipped or assembled by clinching. “Conformingly covers” means a surface of the main portion that conforms to the surface 135. In other words, the main portion 141 comprises two flat portions 141a and 141b (advantageously rectangular) linked by a concave portion 141c. In particular, the concave portion 141c conforms to the central portion 133 and covers same with the surface 135, while the flat portions 141a and 141b cover the contact portion 131 and the contact portion 132, respectively.

The spring member 140 may also comprise two side portions 142 and 143 laterally extending the flat portion 141a and the flat portion 141b, respectively. “Laterally extend” means to extend by a lateral side opposite a central side of the flat portion in question, and whereby the flat portion is connected to the concave portion. It is therefore understood that the two side portions 142 and 143 are perpendicular to the coupling side 121. In other words, one side is parallel to the direction of elongation of the concave portion 141c.

In particular, each side portion 142 and 143 is curved, and comprises a bearing portion that extends opposite the free surface along the direction of elongation of the concave portion 141c (parallel to the direction X when the coupling element is coupled to the terminals). More particularly, the side portion 142 comprises a bearing portion 146 facing the contact portion 131 through the free surface 134. Likewise, the side portion 143 comprises a bearing portion 147 facing the contact portion 132 through the free surface 134.

It is also understood that each side portion can exert a spring effect by resilient deformation. In particular, each side portion can be deformed to allow a bearing portion to move away from the contact portion with which it is opposite.

In addition, each bearing portion 146, 147 is configured to provide a sliding connection with terminals 11a and 12b, each of which comprises, from its contact surface 13a and 14b, an upper portion 15a, 15b and a lower portion 16a, 16b forming a cutaway from the upper portion 15a, 15b so as to provide a contour surface 17a, 17b opposite the contact surface 13a, 14b (FIG. 6). Each bearing portion is, in this respect, configured to bear against the contour surface 17a, 17b in order to exert a spring effect enabling the contact member to be pressed against the contact surface of either of the terminals.

More specifically, the bearing portion 146, together with the contact portion 131, encloses a peripheral contour 18a of the upper portion 15a, while the bearing portion 147, together with the contact portion 132, encloses a peripheral contour 18b of the upper portion 15b, the peripheral contours 18a and 18b being opposite each other with respect to the two terminals 11a and 12b and parallel to the direction X.

Advantageously, the contact member 130 comprises two tabs, referred to as upper tabs 136 and 137 (FIG. 4), and the spring member 140 comprises two further tabs, referred to as lower tabs 148 and 149. Each lower tab faces an upper tab. In addition, a lower tab and an upper tab facing each other extend, from the coupling side, divergently with respect to a plane perpendicular to the plane S and which comprises the direction of elongation of the central portion. In particular, the upper tab 136 faces the lower tab 148, while the upper tab 137 faces the lower tab 149.

The use of upper and lower tabs enables the bearing portions 146 and 147 to be moved away from the contact portions 131 and 132 when the coupling element is engaged in a sliding connection with terminals whose upper portions have a thickness greater than the spacing observed in the free state between a bearing portion and the contact portion facing it.

FIG. 8 is a schematic view of the insulation housing 110, which comprises a main part 111 that conformingly covers and matches the main portion 141 and at least in partly the two side portions 142, 143.

In particular, the conforming cover of the main portion and the two side portions is designed to provide a sliding connection between the insulation housing and the coupling element in the direction in which the central portion extends.

Advantageously, the insulation housing comprises a support beam 113, which extends parallel to the extension direction of the central portion 133, the support beam 113 being vertically in line with the central portion 133 by the free surface 134. The support beam advantageously has an arched profile along a cross-sectional plane perpendicular to its extension direction.

The insulation housing 110 also comprises an abutment wall 112 against which one side of the coupling element, opposite the coupling side, abuts.

Using the connection device to connect the terminals 11a and 12b involves, in particular, engagement of the coupling side of the device in a sliding connection along the direction X. During this engagement, the upper and lower tabs first come into contact with the upper portions of the two terminals 11a and 12b. In particular, this contact between the tabs and the upper portions results in each bearing portion being spaced apart from the contact portion facing it. An insertion force in the direction X then allows the device to slide in order to perfect the coupling between the connection device and the terminals. It is understood that this coupling operation can be carried out exclusively by handling the insulation housing. Alternatively, the reverse operation of removing the connection device, by exerting a force in a direction opposite to the direction X, can be performed. This reverse operation causes no damage to the connection device or the elementary cells.

Advantageously, the concave portion 141c and the central portion 133 can be configured, in particular, by their shape, to resiliently deform when a stress is imposed on them. In particular, such deformation makes it possible to accommodate slight movements of the elementary cells connected by the connection device, while maintaining the quality of the electrical contact between the terminals in question.

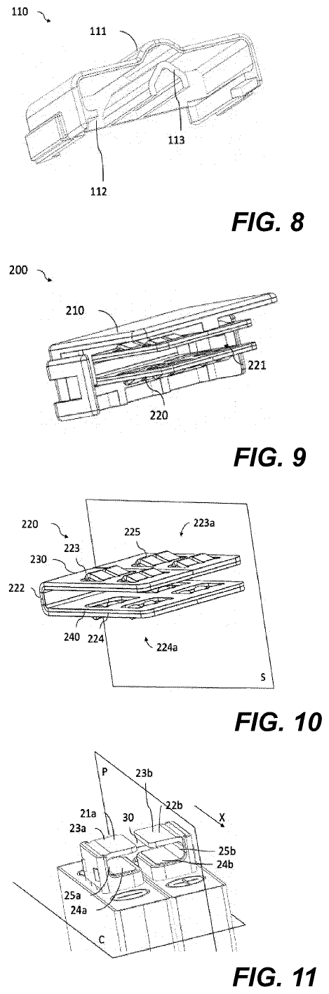

FIG. 9 is a schematic view of a connection device 200 according to a second embodiment of the present disclosure. The connection device 200 comprises an insulation housing 210 and a coupling element 220. In particular, the coupling element 220 is recessed in the insulation housing 210.

The coupling element 220, according to this second embodiment, comprises a base 222 from which two wings 223, 224 extend toward the coupling side 221 such that the coupling element 220 has, in section along the plane S, a U-shaped cross section.

In particular, the coupling element 220 comprises a contact member 230 and a spring member 240, each formed by a metal sheet. In particular, the sheets are glued or welded together. More particularly, the spring member 240 is arranged internally to the contact member, the outer faces 223a and 224a of each of the wings 223 and 224 being intended to be in contact with one and the other of the two terminals 21a and 22b. It is therefore understood, without needing to be specified, that the contact member 230 conformingly covers the spring member 240. In this configuration, the spring member 240 exerts its spring effect directly on the contact member 230.

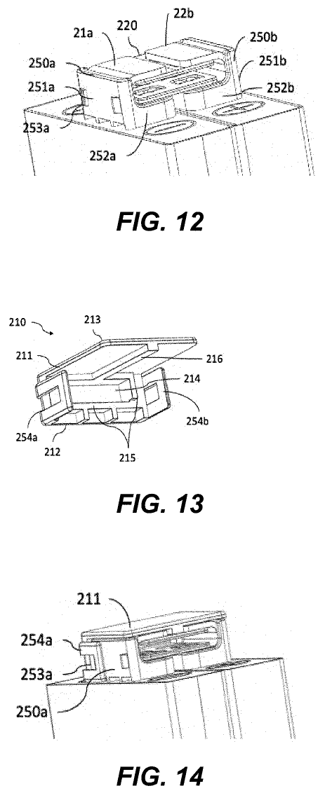

Thus, as shown in FIG. 11 and FIG. 12, the coupling element 220 is configured to be inserted into a passage 30, which extends along direction X, and which is delimited by two coplanar upper end plates 23a and 23b, respectively, of one and the other of the two terminals 21a and 22b, and by two coplanar lower end plates 24a and 24b, respectively, of one and the other of the two terminals 21a and 22b. The upper end plate 23a and 23b and the lower end plate 24a and 24b of each terminal 24a and 24b are, moreover, parallel to a plane C perpendicular to plane P, and connected by an angled portion 25a and 25b. The coupling element is thus configured to internally connect the upper end plates 23a, 23b and the lower end plates 24a and 24b. In this respect, each of the wings 223 and 224 comprises outwardly projecting tabs 225 designed to ensure electrical contact with the upper and lower end plates.

The insulation housing 210 shown in FIG. 13 comprises a handling element 211 provided with an abutment wall 212 and a main wall 213, the main wall 213 being perpendicular to the abutment wall 212 and extending, from the abutment wall substantially parallel to the wings 223 and 224 of the coupling element 220. The insulation housing 210 also comprises embedding means, arranged on an inner face of the abutment wall 212 and configured to hold, by embedding, the coupling element 220 from its base 222. The embedding means comprise ribs 215 delimiting a housing 214 in which the base 222 of the coupling element 220 is embedded.

Advantageously, the main wall 213 comprises a rib, known as the central rib 216, which extends from the abutment wall toward the coupling side and is configured to be interposed between the two upper end plates 23a and 23b when coupling the connection device 200 with the two terminals 21a and 22b.

Advantageously, the insulation housing 210 also comprises two fastening elements 250a and 250b (FIG. 12). Each fastening element 250a and 250b is attached to a terminal 21a and 22b and is designed to snap-fit together with the handling element 211. In particular, the fastening element 250a is secured to terminal 21a, while fastening element 250b is secured to terminal 22b.

The fastening element 250a comprises an insulation wall 251a, externally covering the angled portion 25a, and extending from a pedestal, on which the terminal 21a of the elementary cell 10a rests, and toward the upper end plate 23a.

Likewise, the fastening element 250b comprises an insulation wall 251b, externally covering the angled portion 25b, and extending from a pedestal, on which the terminal 22b of the elementary cell 10b rests, and toward the upper end plate 23b.

In other words, the insulation walls 251a and 251b laterally frame the two terminals 21a and 22b.

Each fastening element 250a and 250b also comprises a fastening base 252a and 252b configured to secure the fastening element to the pedestal of the terminal.

In particular, the fastening element 250a comprises a fastening base 252a configured to secure the fastening element 250a to the pedestal of the terminal 21a.

Likewise, the fastening element 250b comprises a fastening base 252b configured to secure the fastening element 250b to the pedestal of the terminal 22b.

The fastening base 252a is configured to encircle the pedestal of the terminal 21a.

Likewise, the fastening base 252b is configured to encircle the pedestal of the terminal 22b.

Advantageously, each insulation wall 251a and 251b is provided with a lug 253a (FIG. 12) and 253b (not shown), while the handling element 211 is provided with two catch means 254a and 254b, which are configured to engage with the lugs 253a and 253b by snap-fitting in order to fix the coupling between the coupling element and the terminals. More particularly, the catch means 254a and 254b are configured to be engaged with, respectively, one and the other of the lugs 253a and 253b when coupling the connection device in a sliding connection mode in the direction X.

In this respect, each catch means 254a and 254b, may comprise a lateral tab, which extends from the abutment wall 212 and perpendicular to the abutment wall 212 (FIG. 13). More particularly, the lateral tab of the catch means 254a is configured to overlap the insulation wall 251a during the coupling of the connection device and to cooperate with the lug 253a to prevent any movement tending to disengage the connection device from the two terminals.

Likewise, the lateral tab of the catch means 254b is configured to cover the insulation wall 251b during the coupling of the connection device and to cooperate with the lug 253b to prevent any movement tending to disengage the connection device from the two terminals.

The use of the connection device for connection involves, in particular, engaging the coupling side of the device in sliding connection in the direction X. During this engagement, the coupling element 220 is inserted, by the coupling side, between the upper end plates and the lower end plates by a sliding movement in the direction X. The central rib 216 sliding between the upper end plates makes it possible to guide the movement. When the abutment wall 212 comes to rest against either terminal, the movement stops. Concurrently with this stop, the pawl means cooperate with the lugs 253a and 253b to secure the connection device in its final position, in which the wing 223 contacts the upper end plates internally and the wing 224 contacts the lower end plates.

The present disclosure also relates to a battery pack provided with a plurality of batteries stacked in the direction Y and connected to each other by way of connection devices according to either the first or second embodiment.

Of course, the present disclosure is not limited to the described embodiments and variant embodiments may be envisaged without departing from the scope of the invention as defined by the claims.

1. A removable connection device for connecting two elementary cells of a battery pack when the two elementary cells are adjacent along a first plane P and are each provided with a terminal, the two terminals being arranged symmetrically with respect to the P plane, wherein the connection device is symmetrical with respect to a second plane S, which coincides with the P plane when the connection device connects the two terminals, and wherein the connection device comprises a coupling element supported by an insulation housing, the coupling element configured to be coupled in sliding connection with the two terminals along a sliding direction along which the connection device slides while connecting the two elementary cells with the connection device, the coupling element comprising a contact member and a spring member supported so as to be mechanically secured to one another, the contact member configured to establish electrical contact between the two terminals when the coupling element is coupled with the two terminals, the spring member configured to press the contact member against the two terminals by spring effect, the insulation housing being fixed with the coupling element and configured to allow handling of the coupling element while it is being coupled in sliding connection on a coupling side with the two terminals.

2. The connection device of claim 1, wherein the contact member comprises a generally rectangular metal sheet, including two contact portions symmetrical to one another with respect to the second plane S and connected by a central portion, the central portion extending in the sliding direction when the coupling element is coupled to the two terminals, each of the contact portions comprising a portion of a free surface of the contact member configured to bear against a contact surface of each of the terminals, the two contact surfaces being perpendicular to the first plane P.

3. The connection device of claim 2, wherein the spring member comprises a metal sheet having a main portion connected to the contact member by conformingly covering a surface of the contact member opposite the free surface, the spring member comprising two curved side portions arranged on the side of the main portion, each curved side portion comprising a bearing portion extending opposite the free surface in the sliding direction.

4. The connection device of claim 3, wherein each bearing portion is configured to ensure sliding connection with the two terminals, each bearing portion being configured to bear against a contour surface on each of the two terminals to exert a spring effect for pressing the contact member against the contact surfaces of the two terminals.

5. The connection device of claim 4, wherein the contact member comprises two upper tabs and the spring member comprises two lower tabs, each of the two lower tabs respectively facing one of the two upper tabs, the two lower tabs and the two upper tabs facing one another and extending divergently from the coupling side and with respect to a third plane perpendicular to the second plane S and includes an elongation direction of the central portion.

6. The connection device of claim 5, wherein each contact portion comprises stamped contacts projecting relative to the free surface and intended to ensure electrical contact with the contact surface.

7. The connection device of claim 4, wherein the insulation housing comprises a main part conformingly coving and matching the main portion and at least a portion of each of the two curved side portions.

8. The connection device of claim 7, wherein the insulation housing is in sliding connection with the coupling element in an elongation direction of the central portion, and wherein the insulation housing further comprises an abutment wall against which a side of the coupling element opposite the coupling side abuts.

9. The connection device of claim 8, wherein the insulation housing comprises a support beam extending parallel with the elongation direction of the central portion, the support beam being vertically in line with the central portion.

10. The connection device of claim 1, wherein the coupling element comprises a base from which two wings extend toward the coupling side such that the coupling element has, in section along the second plane S, a U-shaped cross section.

11. The connection device of claim 10, wherein both the contact member and the spring member comprise a metal sheet, the two metal sheets being glued together, the spring member being arranged inside the contact member, and wherein outer surfaces of each of the wings are configured to be in contact with the two terminals.

12. The connection device of claim 11, wherein the coupling element is configured to be inserted in a passage defined by surfaces of the two terminals, the passage extending in the sliding direction.

13. The connection device of claim 12, wherein the insulation housing comprises a handling element provided with an abutment wall and a main wall, the main wall being perpendicular to the abutment wall and extending from the abutment wall substantially parallel to the wings of the coupling element, the insulation housing further comprising embedding means arranged on an internal surface of the abutment wall and are configured to support, by embedding, the coupling element from the base thereof on the abutment wall.

14. The connection device of claim 13, wherein the embedding means comprise ribs delimiting a housing in which the coupling element is embedded by the base thereof.

15. The connection device of claim 14, wherein the main wall comprises a central rib extending from the abutment wall toward the coupling side.

16. The connection device of claim 13, wherein the insulation housing further comprises two fastening elements, each fastening element configured to fix to a terminal and intended to engage with the handling element by snap-fitting.

17. The connection device of claim 16, wherein each fastening element comprises an insulation wall configured to cover a portion of a terminal, the insulation wall including a lug, the handling element including two catch means configured to engage with the lugs by snap-fitting to fix a coupling between the contact member and the terminals.

18. The connection device of claim 16, wherein each fastening element comprises a fastening base configured to attach the fastening element to a pedestal on which the terminal rests.

19. A battery pack formed by a plurality of elementary cells stacked against one another in a stacking direction and electrically connected in series by way of connection devices according to claim 1.
